(19) United States
(12) Patent Application Publication
(10) Pub. No.: US 2004/0023089 A1
(43) Pub. Date: Feb. 5, 2004

(54) Polymer electrolyte membrane fuel cell system comprising a cooling medium distribution space and cooling medium collection space, and with cooling effected by fluidic media

(76) Inventor: Andreas Schiegl, Oberhaching (DE)

Correspondence Address: VENABLE, BAETJER, HOWARD AND CIVILETTI, LLP, P.O. BOX 34385, WASHINGTON, DC, 20043-9998, US

(21) Appl. No.: 10/362,169

(22) PCT Filed: Aug. 20, 2001
(86) PCT No.: PCT/EP01/09582

(30) Foreign Application Priority Data
Aug. 21, 2000 (DE) 100 40 792.7

(51) Int. Cl. H01M 8/04; H01M 8/10

(52) U.S. Cl. 429/26; 429/37; 429/32; 429/38

(57) ABSTRACT

The invention relates to a fuel cell system comprising a plurality of individual polymer electrolyte membrane fuel cells (2) arranged one on top of the other in the form of a stack (3) wherein, between adjacent individual fuel cells (2) of the stack (3), there is provided one intermediate space (10) each for receiving a cooling medium (13), or adjacent individual fuel cells (2) are confined by bipolar plates (7) having passages (12) for receiving a cooling medium, and cooling medium distribution spaces (15) and cooling medium collection spaces (18) being provided on lateral faces (23) of the stack. For cooling the fuel cell stack (1), cooling medium flows into a cooling medium distribution space (15) through the intermediate spaces between the individual fuel cells or the passages in the bipolar plates and finally into a cooling medium collection space from where it leaves the fuel cell system.

The present invention relates to a fuel cell system comprising a plurality of individual polymer electrolyte membrane fuel cells arranged one above the other in the form of a stack, said fuel cell system being suitable for cooling using fluid media that are not, weakly or highly electrically conductive. The invention concerns furthermore a method of cooling such a fuel cell system using fluid media that are not, weakly or highly electrically conductive. The fuel cells may be operated with fuel gas and oxidant at low pressure or higher pressure, the fuel gas used being preferably hydrogen or a methanol-water mixture in liquid or gaseous form, and air or oxygen being used as oxidant.

Polymer electrolyte membrane fuel cells contain an anode, a cathode and an ion exchange membrane disposed therebetween. A plurality of individual fuel cells constitutes a fuel cell stack, the individual fuel cells being separated by bipolar plates acting as current collectors. Instead of the bipolar plates, it is also possible to use an anode-side pole plate and a cathode-side pole plate each. For generating electricity, a fuel gas, e.g. Hydrogen, is introduced into the anode region via gas distribution channels, and an oxidant, e.g. air or oxygen, is introduced into the cathode region via gas distribution channels. The introduction of the reactants may take place both under excess pressure (approx. 2×10⁵ to 4×10⁵ Pa) and under approximately atmospheric pressure (approx. 1.1×10⁵ to 1.5×10⁵ Pa abs). In the regions in contact with the polymer electrolyte membrane, the anode and cathode contain a catalyst layer each. In the anode catalyst layer, the fuel is oxidized, forming cations and free electrons, and in the cathode catalyst layer, the oxidant is reduced by absorption of electrons. The cations migrate through the ion exchange membrane to the cathode and react with the reduced oxidant, creating water when hydrogen is used as fuel gas and oxygen is used as oxidant. In the reaction of fuel gas and oxidant, there are set free large amounts of heat that have to be dissipated by cooling. Cooling may be effected both by gaseous media, e.g. air, and by fluid media.

In conventional fuel cell stacks using liquid cooling, cooling is effected by cooling channels in the bipolar plates that are fed from central distribution and collection lines. As there are typically between 20 and 50 up to several hundred individual fuel cells connected in series, the cooling medium in the central supply and discharge channels must be passed through the fuel cell stack along the direction of flow or counter thereto. To prevent the different electrical potentials of the series-connected individual fuel cells from becoming electrically interconnected by the cooling medium, thereby causing short-circuits between the cells or material decompositions, deionized water is used as cooling liquid. However, deionized water has a high absorption capacity for soluble ions of any kind, and thus it has to be continuously replaced or cleaned when it is used in fuel cell systems, e.g. by ion exchanger systems. Such cleaning is often required as the cooling media usually are passed through heat exchanger systems where they are enriched with foreign ions. Such foreign ions do not only undesirably increase the electric conductivity of the cooling medium, but many of the foreign ions (Cu²⁺, Ni²⁺) in addition damage the solid polymer electrolyte membrane in case there is direct contact between cooling medium and membrane.

The choice of suitable cooling media for polymer electrolyte membrane fuel cell systems with conventional cooling thus is severely restricted. There can be no cooling media used which, in direct contact with the membrane, catalyst layer, gas diffusion layer or bipolar plate, could cause damage thereto, as is the case e.g. with oils, cooling water enriched with foreign ions from heat exchanger installations, cooling water with anti-freeze agent or alcohols.

These restrictions with respect to the cooling media suited for use necessitate restrictions in the possibilities of use-of the fuel cell systems. For example, if a fuel cell system using deionized water as cooling medium is deactivated in very cold surroundings, the cooling medium may have frozen until reactivation thereof, causing irreversible damage to the fuel cell system.

Another disadvantage in conventional fuel cell systems are passageways for cooling medium through the fuel cell stack. These are complex in terms of manufacture, necessitate careful sealing and, in addition thereto, consume valuable active area.

Moreover, when the cooling medium is passed through the stack through central supply and discharge channels, the distribution of the cooling medium to the cooling channels of a bipolar plate often is not sufficiently uniform, resulting in portions cooled to higher and lower extents, which is not desirable. Conversely, it is hardly possible to cool fuel cells in the central region of a stack, which as a rule is several Kelvin hotter, to a higher extent than individual fuel cells in the peripheral region of the stack.

It is therefore an object of the invention to overcome the disadvantages of the prior art and to make available a constructionally simple fuel cell system.

Another object of the invention consists in making available a fuel cell system permitting an optimum distribution of cooling medium in accordance with the degree of cooling required.

In particular, it is an object of the invention to make available a fuel cell system that is not restricted to using electrically non-conducting cooling media, but may also be cooled using fluid media that are weakly or strongly electrically conductive.

In addition thereto, it is an object of the invention to make available a fuel cell system that may be cooled with cooling media that may damage any components of the individual fuel cells-upon contact with the same.

The object is met by the fuel cell system comprising a plurality of individual polymer electrolyte membrane fuel cells arranged one on top of the other in the form of a stack, wherein

between adjacent individual fuel cells of the stack, there is provided one intermediate space each for receiving a cooling medium,

on at least one lateral face of the stack, there is arranged at least one cooling medium distribution space having at least one cooling medium inlet opening,

on at least one lateral face of the stack, there is arranged at least one cooling medium collection space having at least one cooling medium outlet opening,

on the lateral faces of the stack having neither a cooling medium distribution space nor a cooling medium collection space arranged thereon, there is provided a sealing agent each between adjacent individual fuel cells on the outer peripheral portions thereof, so that the at least one cooling medium distribution space, the intermediate spaces between adjacent individual fuel cells and the at least one cooling medium collection space constitute a space allowing the flow of cooling medium therethrough.

Moreover, the object is met by the fuel cell system comprising a plurality of individual polymer electrolyte membrane fuel cells arranged one on top of the other in the form of a stack, wherein

adjacent individual fuel cells are confined by bipolar plates having passages for receiving a cooling medium,

on at least one lateral face of the stack, there is arranged at least one cooling medium distribution space having at least one cooling medium inlet opening,

on at least one lateral face of the stack, there is arranged at least one cooling medium collection space having at least one cooling medium outlet opening, and

the at least one cooling medium distribution space, the passages in the bipolar plates and the at least one cooling medium collection space constitute a space allowing the flow of cooling medium therethrough.

In addition, the object is met by the method of cooling a fuel cell system comprising a plurality of individual polymer electrolyte membrane fuel cells arranged one on top of the other in the form of a stack, wherein a space is provided allowing the flow of cooling medium therethrough, said space having

intermediate spaces between adjacent individual fuel cells or passages in bipolar plates of adjacent individual fuel cells and

at least one cooling medium distribution space arranged on a lateral face of the stack, and

at least one cooling medium collection space arranged on a lateral face of the stack, and wherein

a fluid cooling medium is flown through said space allowing the flow of cooling medium therethrough.

The invention will be elucidated in more detail in the following by way of preferred embodiments.

An individual fuel cell is composed at least of the components membrane electrode unit, consisting of membrane, a cathode-side and an anode-side catalyst and gas diffusion layers, and of an anode-side and a cathode-side pole plate and the sealing system. Instead of the anode-side and cathode-side pole plates of adjacent cells, it is also possible to provide a bipolar plate. The pole plates and the bipolar plates often have gas distribution structures incorporated therein or deposited thereon. Each individual fuel cell also requires supply and discharge means for fuel gas and oxidant. The individual fuel cells as a rule are of rectangular shape, but may be of any other different shape desired. The invention will be described in the following in exemplary, non-limiting fashion with reference to rectangular fuel cells.

For cooling the fuel cell system according to the invention, the cooling medium is introduced into the fuel cell stack on one side thereof, flows through the stack, i.e. flows through the intermediate spaces between the fuel cells or through the passages in the bipolar plates, and leaves the stack on the same side or a different side. The cooling medium is preferably circulated in a loop or circuit.

Entry of the cooling medium into the stack is effected from a cooling medium distribution space arranged on a lateral face of the stack.

Upon flowing through the stack, the cooling medium is collected in a cooling medium collection space and discharged from the fuel cell system.

There are numerous variations possible as regards shape, number and arrangement of the cooling medium distribution spaces and collection spaces. For example, a distribution space may extend over an entire lateral face of the fuel cell stack while another lateral face of the stack, preferably the opposite lateral face in case of rectangular fuel cells, has a cooling medium collection space arranged thereon that also extends over the entire lateral face of the stack. With this embodiment, the cooling medium flows through the stack in hydraulic parallel connection. In case the cooling medium distribution space and the cooling medium collection space are not provided on opposite lateral faces of the stack, it is expedient, by introduction of suitable structures in the intermediate spaces between the cells, to provide for guided flow of the cooling medium from its entry into the stack to its discharge from the stack and, respectively, to design the cooling medium passages in the bipolar plates such that they lead from the cooling medium distribution space to the cooling medium collection space.

Cooling medium distribution space and collection space may be of identical or different configuration. The distribution space has a cooling medium inlet opening through which the cooling medium enters the distribution space, and the collection space has a cooling medium outlet opening through which the cooling medium leaves the collection space. In particular with high fuel cell stacks or individual fuel cells of large area, it may be advantageous to provide for a distributing structure in the distribution space for improved flow guidance of the cooling medium. As an alternative or in addition, there may also be provided several cooling medium inlet openings in the distribution space, which also enhance a more uniform distribution of the cooling medium introduced. The collection space also may have several openings, i.e. outlet openings, and contain a cooling medium distributing structure. If desired, the direction of flow of the cooling medium may then be reversed without any problem.

The cooling medium distribution space (the same applying analogously to the collection space) may also be subdivided by partitions into two or more segments or be composed of partial spaces that are each closed. Each segment or each partial space has at least one cooling medium inlet opening.

It is thus possible, for example, to provide three adjacent cooling medium distribution spaces arranged on top of each other in stacking direction on a lateral face of the stack, with more or colder cooling medium being flown into the middle cooling medium distribution space than into the other two cooling medium distribution spaces. This results in stronger cooling of the individual fuel cells in the central region of the stack, which in case of uniform cooling of the stack would be at a higher temperature than the cells in the peripheral portion of the stack. The same effect is achieved when cooling medium of equal temperature and equal amount is flown into the cooling medium distribution spaces, whereas the central cooling medium distribution space supplies cooling medium to fewer individual fuel cells than the other two distribution spaces, so that in the central region of the stack there is a higher flow speed, thus achieving a better cooling effect in the center.

According to a further modification of the fuel cell system according to the invention, cooling medium distribution spaces and/or cooling medium collection spaces may be arranged on several lateral faces of the stack. This is advantageous in particular in case of specific cell shapes, for example octagonal fuel cells, for ensuring uniform cooling medium flow.

Fuel cell systems in which the cooling medium flows through intermediate spaces between the pole plates confining adjacent individual fuel cells, must be sealed by a suitable sealing means at those locations where no cooling medium distribution space and no cooling medium collection space is provided, so that the cooling medium cannot leak out from the intermediate spaces. Suitable as sealing agent is any material that is resistant to the cooling medium and withstands the fuel cell working temperatures. For example, the intermediate spaces between the individual fuel cells may be sealed on their outer peripheral portions by means of silicone strips so that, seen from outside, a stacking sequence of individual fuel cell—sealing means—individual fuel cell—sealing means etc. is formed. The sealing means may be adhesively attached to the pole plates of the adjacent individual fuel cells or may be self-adhesive thereto, or it is also possible to insert sealing means strips between the individual fuel cells in non-adhesive manner, so that the cooling-medium-tight sealing effect results only after tightening together of the individual fuel cells so as to form a stack.

In the intermediate spaces between the individual fuel cells, i.e. between the pole plates confining the cells, there are preferably arranged spacer structures. In addition to securing the optimum spacing between the individual fuel cells, these spacer structures may take over additional functions. When consisting of electrically conductive material, they may establish electrical contact between anode-side pole plate and cathode-side pole plate of adjacent individual fuel cells. In addition thereto, their shape may be selected such that they direct the cooling medium through the intermediate spaces along a desired path.

For example, one possibility consists in providing in the intermediate spaces spacers in the form of strips extending in rectilinear or corrugated manner in a desired distance from each other from one lateral face of the stack to the opposite lateral face of the stack. As an alternative, it is also possible to provide curved spacers beginning and terminating on the same lateral face of the stack. With such curved spacers, it is possible to accommodate cooling medium distribution space and cooling medium collection space on the same lateral face of the stack. Preferred is a combined cooling medium distribution space/collection space having a partition extending centrally or about centrally in stacking direction. The partition preferably should be thermally insulating so as to prevent heat exchange between cold and heated cooling medium. The partition separates the cooling medium space into two segments, one segment being the cooling medium distribution space and the other segment being the cooling medium collection space. The segments preferably are of equal size, but may be of different sizes as well. As an alternative, it is also possible to make use of two separate cooling medium spaces that are connected to each other, e.g. welded or adhesively connected. With these modifications, there is only one lateral face of the stack provided with a cooling medium distribution space/collection space. The remaining three lateral faces of the stack are sealed by seals in the intermediate spaces between the individual fuel cells. A particular advantage of these modifications is the savings of weight on the one hand by material savings and on the other hand by the lesser quantity of cooling medium in the stack. In this case, the cooling medium, on one half of a lateral face of the stack, flows into the intermediate spaces between the individual fuel cells, in a curved path through the intermediate spaces and out of the stack on the other half of the same lateral face. Due to the fact that the flow paths of the cooling medium are shorter in a central portion of an intermediate space than in the marginal portions, there is enhanced cooling taking place here, which is advantageous in so far as the individual fuel cells, in the central region thereof, are mostly hotter than in their peripheral regions.

The same holds analogously for the embodiment with cooling medium passages in the bipolar plates between the individual fuel cells. Sealing of intermediate spaces, of course, may be dispensed with here.

In the modification with combined cooling medium distribution space/collection space on the same lateral face of the fuel cell stack, the cooling medium distribution space and the cooling medium collection space of course may be subdivided further in stacking direction, with each part having at least one cooling medium inlet opening and at least one cooling medium outlet opening, respectively. Different cooling effects in various regions of the fuel cell stack are possible in this manner as well.

The effect presenting itself in case of curved cooling medium flow paths is that the flow paths are of different lengths. If uniform cooling is desired within a plane, i.e. in an intermediate space or in a bipolar plate, it is expedient to choose the width of the flow paths such that the pressure drop is the same for each flow path. Long flow paths thus should be wide, whereas short ones should be narrower.

For obtaining cooling to different extents in the central region of the stack and in the end regions of the stack, the flow paths for the cooling medium may also be of different widths in the corresponding regions.

The spatial arrangement or orientation of the fuel cell system according to the invention, i.e. the direction of flow of the cooling medium, is of arbitrary nature.

The fuel cell system according to the invention as well as the method of cooling the fuel cell system according to the invention basically require just the presence of two individual fuel cells, but usually there will be provided a plurality of fuel cells that are stacked in the form of a fuel cell stack of typically about 10 to 100 fuel cells. On the top and bottom sides of the stack, there are provided current collectors each, typically in the form of current-collecting sheet-metal members and current-discharging sheet-metal members. The fuel cells and the current collectors are electrically connected in series. The fuel cell stack finally is concluded by end plates attached to the respective side of the current collectors facing away from the stack.

As mentioned hereinbefore, fuel cell stacks with intermediate spaces between the individual fuel cells preferably have spacer structures in the intermediate spaces. These spacer structures may be made of an electrically conductive material, such as metal or carbon-containing materials, e.g. carbon paper, with porous structures and may act at the same time as electrical connectors between the individual fuel cells. However, it is also possible to employ electrically non-conductive spacer structures, e.g. of plastics material, and to provide separate electrical connectors. The spacer structures may be separate components, but they may also be formed integrally with a pole plate or integrally with two pole plates. Preferred materials for the spacer structures are electrically conductive materials. In case of an integral design with one or both of the adjacent pole plates, they consist of a material identical to that of the pole plates, typically metal or carbon-containing materials.

The dimensions of the intermediate spaces must be selected such that they permit unhindered flow of the cooling medium and uniform cooling. Depending on the size of the fuel cells, a distance considered suitable between adjacent cells may be from 0.1 to 10 mm, preferably 0.2 to 5 mm, and in particularly preferred manner 0.2 to 1 mm. A spacer structure provided in the intermediate spaces should impede the cooling medium flow as little as possible. Spacer structures forming channel-shaped or pore-shaped structures for the cooling medium are preferred. The statements made above hold analogously for the dimensions and the shape of the cooling medium passages in the bipolar plates.

Due to the stacking sequence of fuel cell—intermediate space (with spacer structure) or bipolar plate with passages—fuel cell etc., a hydraulic parallel connection of the cooling medium transversely through the fuel cell stack is effected, thereby achieving very uniform cooling with very low pressure differences. The pressure loss, depending on the size fo the fuel cells and the heat absorption of the cooling medium, typically is in the range from some hundred Pascal to some thousand Pascal.

In addition to the intermediate spaces between the individual fuel cells, there may be provided one additional intermediate space each between the lowermost and, respectively, the uppermost fuel cell of a stack and the respectively adjacent current collector. These additional intermediate spaces provide for the advantage that cooling medium flows also over the lowermost and the uppermost pole plate of a stack, respectively. In this case, an electrical connection between these final pole plates and the current collector is required.

The individual fuel cells may be commercially available polymer electrolyte membrane fuel cells, having e.g. non-woven carbon fiber electrodes, pole plates or bipolar plates of metal or graphite or graphite-plastics composite materials and a Nafion® membrane or a Gore membrane.

The shape of the cooling medium distribution space and the cooling medium collection space basically is of arbitrary nature, provided that a cooling medium-tight connection to the stack is ensured. For example, there may be employed a U-shaped sheet material piece that is applied to a lateral face (lateral face on the side of cooling medium inlet) of the stack such that the two U-legs enclose the peripheral portion of the two adjacent lateral faces of the stack, with a sealing agent, e.g. silicone or butyl caoutchouc, providing for cooling medium tightness between the lateral faces and the U-legs. The space confined by the sheet material and the lateral face on the side of the cooling medium inlet may be closed upwardly and downwardly, for example, by the two stack end plates, with a suitable sealing agent being used here, too. The cooling medium distribution space and the cooling medium collection space, however, may also have the shape of a trough with dimensions matching the corresponding lateral face. The trough is adhesively attached by means of sealing agent and/or threadedly attached. For creating a larger sealing area, the side walls of the trough may be bent inwardly. The bent-over portions have sealing agent or adhesive applied thereto and are attached to the outer peripheral portion of the lateral face of the stack. Suitable sealing agents and adhesives for the afore-mentioned purposes are e.g. silicone, silicone adhesives and butyl caoutchouc.

A further exemplary modification to be indicated is a trough having a basic area corresponding in its shape to the lateral face of the stack, but being slightly larger than the same, so that the trough can be set onto the stack. To provide sealing, a sealing agent is applied between the trough side walls and the stack side walls as well as between the trough side walls and the stack end plates. In this manner, the cooling medium space is also employed for clamping or tightening together of the stack.

In case of use of electrically conducting cooling media, it is advisable to employ non-conducting materials for all components. The bipolar plates or pole plates, the current collectors and the electrical connectors, e.g. the spacer structure between the individual fuel cells (when the same acts as electrical connector), of course, have to be made of electrically conductive material at all times. When a conductive or an aggressive cooling medium is used, these components are coated with a corresponding protective layer, e.g. insulating varnish in case of conductive cooling media, or another material that is resistant to the cooling medium used. The fuel cell stack, inclusive of the spacers, preferably is assembled completely and then coated with insulating varnish, e.g. by dip-coating. In this manner, the entire fuel cell stack is completely encapsulated, insulated and protected.

For supplying fuel gas and oxidant to the individual fuel cells, the individual fuel cells each have at least one fuel gas supply and at least one fuel gas discharge as well as at least one oxidant supply and at least one oxidant discharge. These reactant supply and discharge means have to be arranged and sealed in such a manner that there is no contact possible whatsoever between reactants and cooling media. In the fuel cell system according to the invention, there is provided for complete decoupling of the media oxidants—fuel gas—cooling media and the respective sealing systems in the individual fuel cells and in the fuel cell stack. Due to the decoupling of the sealing systems, the fuel cell stack may be composed of individual cells that were examined as to tightness already prior to assembly thereof. It is merely necessary to seal the individual gas supply channels and gas discharge channels for fuel gas and oxidant between the individual fuel cells.

Sealing for the cooling medium is effected solely outside of the individual fuel cells, i.e. via the lateral faces and end plates of the fuel cell stack or merely on the lateral faces of the fuel cell stack, and thus is remote from the immediate fuel cell interior. Problems as in case of fuel cell systems in which sealing of the individual media-carrying layers in the individual cells as well as of the media supply channels and media discharge channels is effected only upon complete assembly of the stack, namely problems due to the different nature of the individual media sealing systems, are avoided.

A preferred type of decoupling all media consists in providing in each individual fuel cell between membrane electrode unit and the pole plates or bipolar plates adjacent both sides thereof, seals such that partial regions of the pole plates or bipolar plates, respectively, are located externally of said seal, these partial regions being non-overlapping regions for the anode-side pole plate (bipolar plate) and the cathode-side pole plate (bipolar plate). These may be corner portions, but also other, e.g. central portions, so that, for example, a cross-flow of the reaction gasses results. The region internally of the seal between membrane electrode unit as well as anode-side and cathode-side pole plate (bipolar plate), respectively, is the active reaction region including supply and discharge for the particular reaction gas required. In the regions externally of the seal, there are provided the supply and discharge means of the reaction gas not required in the respective active reaction region, which are each sealed separately. This arrangement is particularly advantageous in that the fuel gas supply and discharge means as well as the oxidant supply and discharge means are arranged in the space having cooling medium flowing therethrough, thus having the cooling medium flowing therearound. Penetration of cooling medium into the reaction gas circuits or loops nevertheless need not be feared, since there is a higher pressure present in the individual fuel cells than in the cooling medium system.

The individual fuel cells must be sealed such that no cooling medium enters the interior of the fuel cells. It is immaterial in this regard, whether each individual cell is sealed separately or whether such sealing is effected only when the fuel cells are tied together to form a stack. The requirements as regards the sealing of the individual fuel cells with respect to the cooling medium can be fulfilled relatively easily, as there is a higher pressure prevailing in the individual fuel cells than in the cooling medium system. Typical fuel gas pressures are from about 0.1×10⁵ to 0.5×10⁵ Pa above atmospheric pressure and typical oxidant pressures are from about 0.1×¹⁰⁵ to 0.5×10⁵ Pa above atmospheric pressure. However, the fuel cell system according to the invention is suitable in principle for any pressures on the side of the fuel gas and on the side of the oxidant gas, e.g. also for pressures of 2×10⁵ to 4×10⁵ Pa or higher. The penetration of cooling medium into the fuel cells is thus not promoted.

The supply and discharge of the reaction gasses into or out of the space having the cooling medium flowing therethrough takes place preferably through passages in the end plates. The cooling medium proper may also be supplied and discharged through passages in the end plates if the end plates are part of the cooling medium distribution space and the cooling medium collection space, respectively.

Due to the design of the fuel cell system according to the invention, in case tap water is used as cooling medium, the heated cooling medium can be coupled directly into a circuit for water for industrial use. However, it is also possible to make use of a heat exchanger. Anyway, due to the low loss of pressure during flow through the fuel cell system, only low pump capacity is required for pumping, so that e.g. a plain centrifugal pump may be employed.

To be stressed as particular advantages of the fuel cell system according to the invention is that the system is of constructionally very simple design, that the cooling medium distribution spaces and cooling medium collection spaces add only little weight to the overall system, that cooling medium circuit and reactant circuits are completely decoupled and that excellent, uniform cooling is ensured, which may be matched to the temperature differences within a stack, if desired.

As an alternative to the embodiments described, having cooling medium distribution spaces and cooling medium collection spaces, the fuel cell stack may may also be surrounded completely by a cooling medium jacket having cooling medium flowing therethrough, or may be inserted into a container having cooling medium flowing therethrough. This has the disadvantage of increase weight, but the advantage that, as the cooling medium surrounds the entire fuel cell stack, the exit of reaction gasses from the cells to the atmosphere is prevented, i.e. the system is inherently safe against leakage on the fuel gas side as well as on the air/oxygen side. Conversely, the entry of the cooling medium into the reaction gas circuits can be prevented as the pressure in the reaction gas circuits is above the pressure of the cooling medium circuit.

The cooling medium jacket may be of integral design or may be composed of several parts that are welded, adhesively joined together or otherwise tightly connected. For example, a separate cooling medium distribution space and cooling medium collection space may be provided that are connected, along the lateral faces of the fuel cell stack that are not covered by these spaces, each time to a plate, so that a continuous cooling medium jacket results.

As materials for the cooling medium distribution space, the cooling medium collection space, optionally the cooling medium jacket, and the distributing structure in the cooling medium distribution space, there are preferably employed non-conductive plastics materials, e.g. polypropylene or polyvinylidene fluoride. However, this is not a cogent requirement. In case of cooling with a non-conducting cooling medium, it is basically possible as well to use electrically conductive materials, for example high-grade steel, aluminum or titanium. It is merely necessary that the bipolar plates or pole plates, respectively, as well as the current collectors and the connectors establishing the electric contact among the fuel cells or optionally between fuel cells and current collectors, respectively, have no electrical contact with the cooling medium distribution space, the cooling medium collection space or the cooling medium jacket. In case electrical insulation cannot be ensured by way of intermediate spaces between the conducting components, electrically insulating layers have to be provided for at appropriate locations.

In case of an electrically conducting cooling medium jacket, it is possible for electrical insulation, for example, to apply an electrically insulating layer to the inside of the cooling medium jacket lateral face adjacent the fuel cell stack, or an intermediate space may be left free between cooling medium jacket lateral faces and the opposite lateral faces of the fuel cell stack. Such an intermediate space at the same time entails the advantage that cooling medium also flows along the outer faces of the fuel cell stack. Such an intermediate space typically would have a width of up to 10 mm, preferably however up to about 1 mm only, in order to make sure that the cooling medium preferably flows through the intermediate spaces between the cells.

In the preferred modification, the separate provision of at least one cooling medium distribution space and at least one cooling medium collection space, either on the same lateral face or on different lateral faces of the fuel cell stack, the problem of electrical contact is usually not present, as the contacting locations of cooling medium distribution space and cooling medium collection space as a rule have a sealing agent applied thereto, such as e.g. silicone or butyl caoutchouc, that has an electrically insulating effect.

In the following, particularly preferred embodiments of the invention will be elucidated in more detail with reference to the figures in which

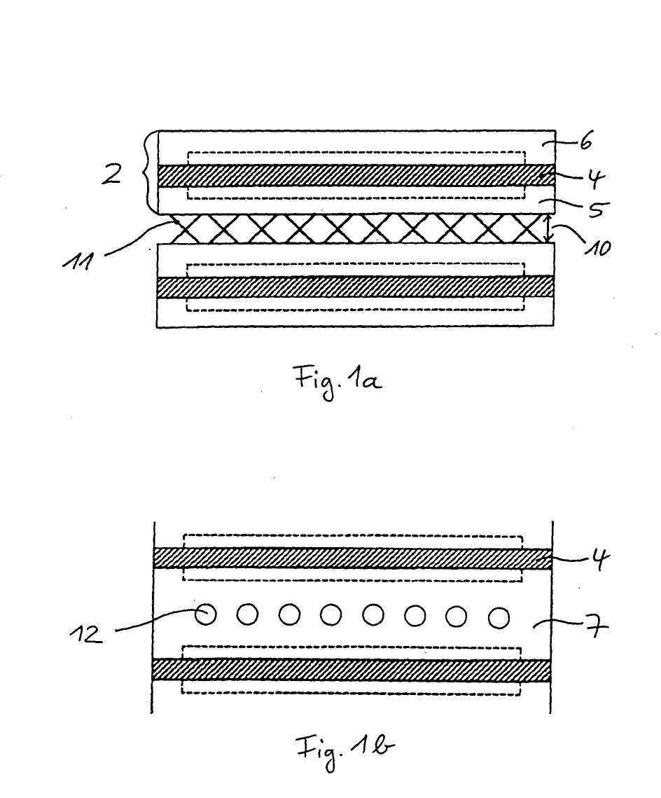

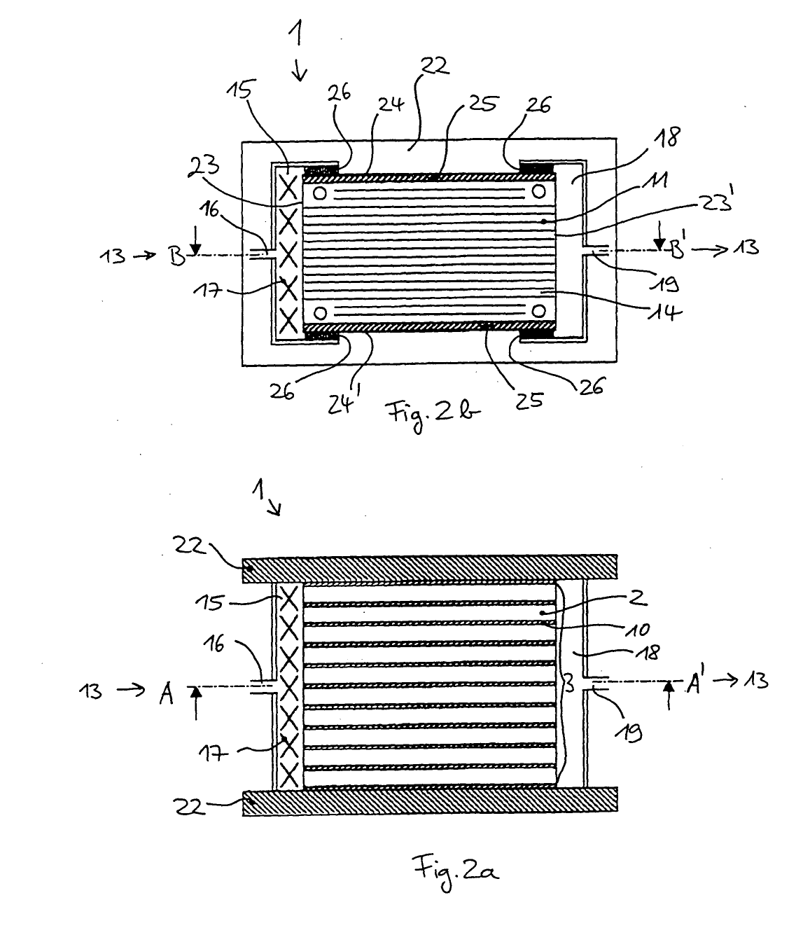

FIG. 1a shows a sectional view of two adjacent fuel cells in stacking direction, i.e. the sectional plane contains the longitudinal axis of the fuel cell stack, along with a spacer structure arranged therebetween;

FIG. 1b shows a sectional view of two adjacent fuel cells in stacking direction, illustrating passages in the bipolar plate arranged therebetween;

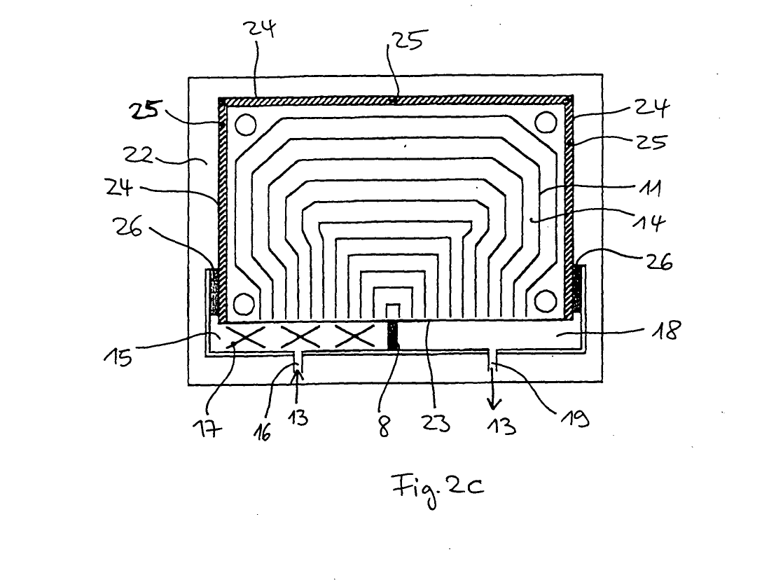

FIG. 2a shows a sectional view of a fuel cell system according to the invention in stacking direction;

FIGS. 2b and 2c show a sectional view of a fuel cell system according to the invention in the plane of an intermediate space between adjacent individual fuel cells, each with a different arrangement of cooling medium distribution space, cooling medium collection space and spacer structures;

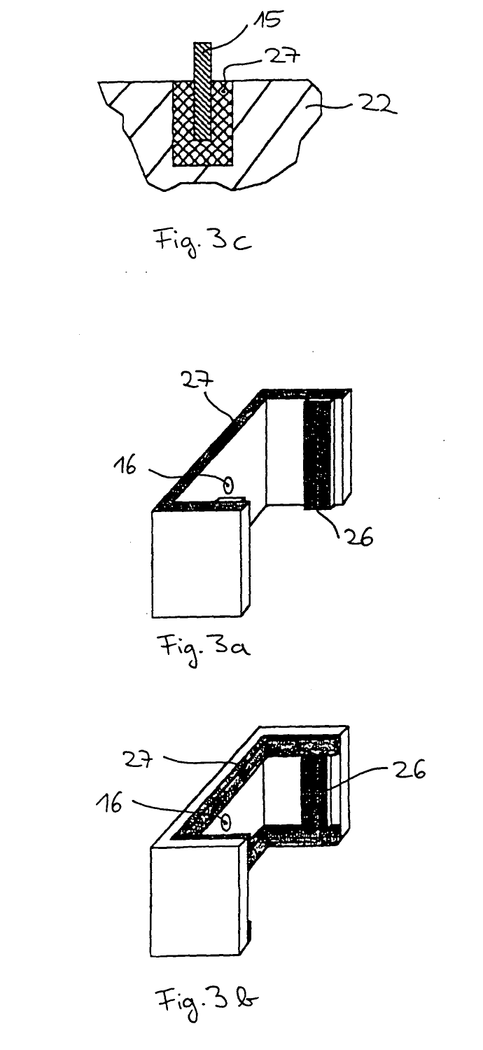

FIGS. 3a and 3b show a wall of a cooling medium distribution space according to the invention, each illustrating a different application of sealing agent;

FIG. 3c shows a seal according to the invention between cooling medium distribution space wall and stack end plate;

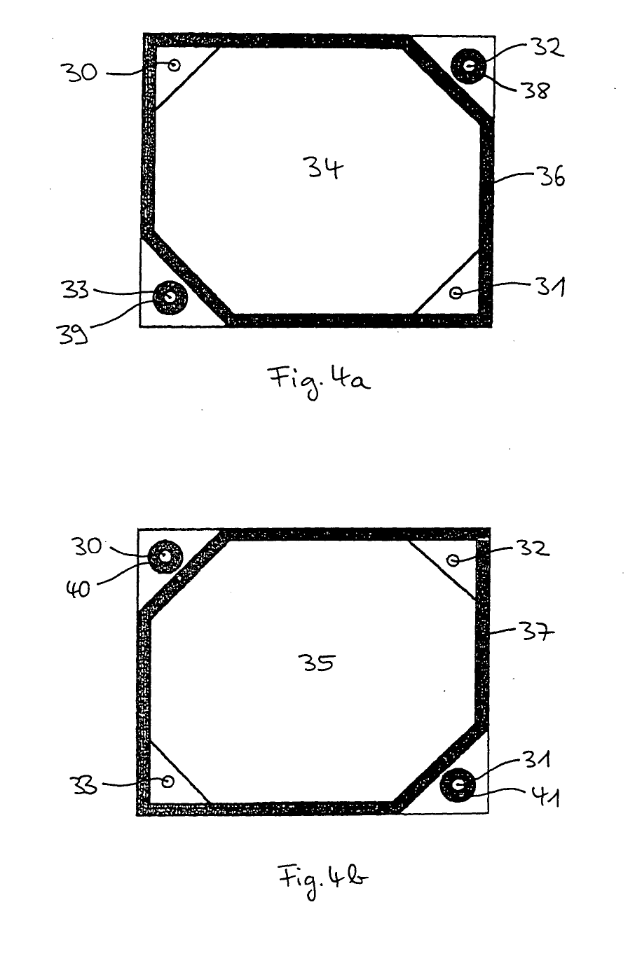

FIG. 4a shows a plan view of a seal according to the invention between the membrane electrode unit and the anode-side pole plate, along with supply and discharge of oxidant; FIG. 4b shows a plan view of a seal according to the invention between the membrane electrode unit and the cathode-side pole plate, along with supply and discharge of fuel gas.

The same reference numerals in the figures designate like or corresponding component parts.

As can be seen from FIG. 1a, an individual fuel cell 2 basically is composed of the components membrane electrode unit 4—consisting of membrane, cathode-side and anode-side catalyst layers and gas diffusion layers—as well as of a anode-side 5 and a cathode-side 6 pole plate and the sealing system. The pole plates have gas distribution structures incorporated therein, which are indicated in FIG. 1a by broken lines. Between the two fuel cells, there is provided an intermediate space 10, with electrical contact between the anode-side pole plate of one cell and the cathode-side pole plate of the adjacent cell being ensured by an electrically conductive spacer structure 11 in the intermediate space 10. The spacer structure 11 has passages for a cooling medium 13 flowing along the surface of the anode-side pole plate 5 of one cell and the surface of the cathode-side pole plate 6 of the neighboring cell and thus cooling the cells. The passages for the cooling medium are preferably channel- or pore-shaped structures. The spacer structure 11 may either be part of a pole plate of an individual fuel cell, part of adjacent pole plates of two fuel cells or an independent component.

FIG. 1b also illustrates two adjacent individual fuel cells as shown in FIG. 1a. However, the individual fuel cells in this case are not separated from each other by an intermediate space, but have a common bipolar plate 7 with passages 12 for a cooling medium 13. The passages 12 are shown with circular cross-section, but may also have a different configuration. Configuration, width and arrangement of the passages 12 in the bipolar plate 7 are basically of arbitrary nature, as long as sufficient cooling medium can flow therethrough.

FIG. 2a illustrates a sectional view of a fuel cell system according to the invention in stacking direction. Between the individual fuel cells 2 as well as between the first and last fuel cells of the stack 3 and the respective adjacent current collector on the end plate 22, there are provided intermediate spaces 10 through which cooling medium 13 flows during operation. On two opposing lateral faces of the fuel cell stack 3, there is schematically illustrated a chamber-like space each. The space shown to the left in FIG. 2a is the cooling medium distribution space 15 into which a cooling medium inlet opening 16 opens and in which a cooling medium distributing structure 17 is provided. The space shown to the right in FIG. 2a is the cooling medium collection space 18 having a cooling medium outlet opening 19. The fuel cell system is confined upwardly and downwardly by the two end plates 22 projecting beyond the arrangement of fuel cell stack 3, cooling medium distribution space 15 and cooling medium collection space 18. Upon tightening together the stack 3, cooling medium distribution space and cooling medium collection space are simultaneously tightened as well. For sealing between the cooling medium distribution space 15 and the cooling medium collection space 18, respectively, and the end plates 22, there is preferably used a sealing agent that can be removed again without damage to the connected parts, for example silicone, silicone adhesives or butyl caoutchouc, so as to permit maintenance work on the fuel cell stack without any problem. The two end plates 22 have passages therein (not shown here) for supplying fuel gas and oxidant to the fuel cell stack and for discharging fuel gas and oxidant from the fuel cell stack. Inlet openings and outlet openings for cooling medium into the cooling medium distribution space or from the cooling medium collection space may be provided in the end plates as well. Upon operation of the fuel cell stack 1, cooling medium 13 enters into the cooling medium distribution space 15 at the cooling medium inlet opening 16, flows through the intermediate spaces 10 between the individual fuel cells 2, along the surfaces of the pole plates 5, 6, and reaches the cooling medium collection space 18 and leaves the same again though the cooling medium outlet opening 19. Spacer structures 11 are illustrated in the intermediate spaces 10 by way of broken lines.

FIG. 2b shows a sectional view of the fuel cell system 1 of FIG. 2a along the line AA′, i.e. a section through an intermediate space 10 between two individual fuel cells 2 perpendicular to the stacking direction. The intermediate space 10 has spacers 11 therein, shown in the form of parallel lines, which at the same time act as electrical connectors between the pole plates of the adjacent individual fuel cells. The cooling medium 13 flows through the intermediate spaces 14 between the spacers 11. On two opposing lateral faces 23, 23′ of the fuel cell stack, there are provided a chamber-like cooling medium distribution space 15 and a chamber-like cooling medium collection space 18 each, which are illustrated in FIG. 2b as being of identical design, which however is not cogently necessary. For forming the cooling medium distribution space and the cooling medium collection space, a sheet material piece of U-shaped cross-section is slid over the lateral faces 24, 24′ of the stack in the manner of a bracket each, and a sealing agent 26 is applied to the points of contact between cooling medium distribution space and stack lateral faces 24, 24′. On two opposing edges of each intermediate space 10, there is provided a strip of sealing agent 25 each, sealing the intermediate space 10 towards the outside. The sealing agent 25 each extends over the entire length of the intermediate space, and thus also into the region covered by the seals 26. The stack lateral faces 24, 24′ thus consist here of sealing agent 25 and individual fuel cell face sides in alternating fashion.

In operation, cooling medium 13 thus flows through the cooling medium inlet opening 16 into the cooling medium distribution space 15 having the cooling medium distributing structure 17 therein, enters the stack 3 at the stack lateral face 23, flows through the cooling medium flow paths 14, leaves the space on the opposite stack lateral face 23′, enters the cooling medium collection space 18 and leaves the same through the cooling medium outlet opening 19. Owing to the sealing agent 25, there is no cooling medium leakage occurring at the lateral faces 24, 24′.

In a section of the embodiment shown in FIG. 2b along the line BB′, the representation according to FIG. 2a results.

FIG. 2c also shows a section through a fuel cell system according to the invention in the plane of an intermediate space between two individual fuel cells, but in the instant case the cooling medium distribution space 15 and the cooling medium collection space 18 are arranged on the same lateral face 23 of the fuel cell stack. Thus, a combined distribution/collection space is formed which, seen from outside, has the same shape as a cooling medium distribution space and collection space, respectively, according to FIG. 2b. A thermally insulating partition 8 extending approximately centrally in stacking direction separates the space into two segments that are each accessible separately, the segment of the cooling medium distribution space 15 through the inlet opening 16 and the segment of the cooling medium collection space 18 through the outlet opening 19. By means of the spacer structure 11 there are formed cooling medium flow paths 14 having a curved shape and directing the cooling medium from its entry on one half of the stack lateral face 23 to its exit on the other half of the stack lateral face 23, distributing the cooling medium as uniformly as possible in the intermediate space. On the remaining lateral faces 24 of the stack, there is provided a sealing agent strip 25 at the edge of each intermediate space, so as to prevent leakage of cooling medium.

FIGS. 3a and 3b each illustrate a wall for a cooling medium distribution space 15 of U-shaped cross-section according to the invention. A cooling medium collection space 18 of course may be of identical design. On the inside of the U-legs engaging over the stack lateral faces 24, 24′ upon attachment of the wall of the cooling medium distribution space to the fuel cell stack 3, there is provided a sealing agent 26 for laterally sealing the cooling medium distribution space. In the embodiments according to FIGS. 3a and 3b, the stack end plates 22 are also used to form the cooling medium distribution space. When the end plates project sufficiently beyond the basic area of the fuel cell stack 3, as indicated in FIGS. 2a to 2c, the end plates may simply be applied to the U-shaped sheet material piece and the resulting edges may be sealed by a sealing agent 27 as shown in FIG. 3a. When the end plates on the lateral faces 24, 24′ of the stack 3 do not project beyond the basic area of the stack, the sealing agent 27 for sealing to the stack end plates may be applied to the insides of the U-shaped sheet material piece as shown in FIG. 3b.

Another modification of a connection between an end plate 22 and the sheet material constituting the cooling medium distribution space is illustrated in FIG. 3c. The end plates 22 have a peripheral groove formed therein that corresponds to the U-shaped sheet material piece, with the base of the groove necessarily being slightly larger than the wall thickness of the sheet material piece. A sealing agent is introduced into the groove, and then the sheet material piece is lowered or pushed into the sealing agent.

FIGS. 4a and 4b illustrate a preferred embodiment of the decoupling feature of the cooling medium circuit from the circuits carrying fuel gas and air/oxygen, according to the invention. Between the membrane electrode unit of an individual fuel cell and the anode-side and cathode-side pole plates, there are provided seals each. FIG. 4a shows a plan view of an anode side of a membrane electrode unit having a seal 36 towards the anode-side pole plate. Seal 36 surrounds an active reaction region 34, but leaves free two mutually opposite corner portions of the membrane electrode unit. The fuel gas supply 30 and the fuel gas discharge 31 are within the active reaction region 34, whereas the oxidant supply 32 and the oxidant discharge 33 are located outside of the active reaction region 34. The oxidant supply and the oxidant discharge are sealed with respect to the cooling medium 13 by seals 38 and 39.

FIG. 4b illustrates a corresponding arrangement on the cathode side. The seal 37 between membrane electrode unit and pole plate delimits an active reaction region 35. The oxidant supply 32 and the oxidant discharge 33 are located internally of the active reaction region 35. Oppositely arranged corner portions of the membrane electrode unit for the fuel gas supply 30 having a seal 40 as well as the fuel gas discharge 31 having a seal 41 are arranged externally of the seal 37.

The corner portions of the membrane electrode unit arranged externally of the seal 36 and the corner portions of the membrane electrode unit arranged externally of the seal 37 do not overlap each other. This arrangement ensures intersection-free supply and discharge of the reaction gasses to the active reaction regions of the individual fuel cell without contact to the cooling medium, but with the cooling medium flowing around the supply and discharge means.

The construction according to the invention permits the use of electrically non-conducting, weakly conducting or highly conducting fluid media for cooling, since there is a complete separation and enclosure of the cooling medium with respect to the active membrane zone and, if necessary—in particular in case of highly conducting or aggressive fluid media—, both the individual fuel cells and the fuel cell stack may be provided with an electrically not conducting insulating layer or a protective layer that is resistant to the aggressive medium.

This results in a number of advantages:

The fuel cell stack may even be operated with such cooling media which, in case of direct contact with membrane, catalyst layer, gas diffusion layer, sealing system and/or pole plates, could cause damage of the same (e.g. oils, cooling water enriched with foreign ions (Cu²⁺, Ni²⁺) from heat exchanger installations, cooling water with anti-freeze agent, alcohols).

The fuel cell system can be made “winter-proof” by selecting a suitable cooling medium; i.e. freezing of the fuel cells in a large range of temperatures below freezing can be prevented e.g. by addition of anti-freeze additives to the cooling medium.

Irrespective of this, the construction according to the invention, at least when the same has a cooling jacket, is also significant in terms of safety aspects when conventional cooling media are used, since the fuel cell system provides for inherent safety with respect to the leakage of fuel gas as the latter will be taken up completely by the cooling medium in case of a leak and cannot escape to the environment.

Remarkable is also the technically very uncomplicated structure of the system and the weight savings attainable, in particular when a combined cooling medium distribution/collection space is employed.

Finally, the following aspects should be pointed out in addition which are of relevance to the invention:

The longitudinal axis of the fuel cell system may be vertical (as in the embodiments illustrated), horizontal or also inclined. The cooling medium preferably is a liquid cooling medium.

1. A fuel cell system (1) comprising a plurality of individual polymer electrolyte membrane fuel cells (2) arranged one on top of the other in the form of a stack (3),
characterized in that
between adjacent individual fuel cells (2) of the stack (3), there is provided one intermediate space (10) each for receiving a cooling medium (13),
on at least one lateral face (23) of the stack (3), there is arranged at least one cooling medium distribution space (15) having at least one cooling medium inlet opening (16),
on at least one lateral face (23, 23′) of the stack (3), there is arranged at least one cooling medium collection space (18) having at least one cooling medium outlet opening (19),
on the lateral faces (24) of the stack (3) having neither a cooling medium distribution space (15) nor a cooling medium collection space arranged (18) thereon, there is provided a sealing agent (25) each between adjacent individual fuel cells (2) on the outer peripheral portions thereof, so that the at least one cooling medium distribution space (15), the intermediate spaces (10) between adjacent individual fuel cells (2) and the at least one cooling medium collection space (18) constitute a space allowing the flow of cooling medium (13) therethrough.

2. A fuel cell system (1) comprising a plurality of individual polymer electrolyte membrane fuel cells (2) arranged one on top of the other in the form of a stack (3),
characterized in that
adjacent individual fuel cells (2) are confined by bipolar plates (7) having passages (12) for receiving a cooling medium (13),
on at least one lateral face (23) of the stack (3), there is arranged at least one cooling medium distribution space (15) having at least one cooling medium inlet opening (16),
on at least one lateral face (23, 23′) of the stack (3), there is arranged at least one cooling medium collection space (18) having at least one cooling medium outlet opening (19), and
the at least one cooling medium distribution space (15), the passages (12) in the bipolar plates (7) and the at least one cooling medium collection space (18) constitute a space allowing the flow of cooling medium (13) therethrough.

3. A fuel cell system (1) according to claim 1 or 2,
characterized in that the at least one cooling medium distribution space (15) and the at least one cooling medium collection space (18) are arranged on two mutually opposite lateral faces (23, 23′) of the stack (3).

4. A fuel cell system (1) according to claim 1 or 2,
characterized in that the at least one cooling medium distribution space (15) and the at least one cooling medium collection space (18) are arranged the same lateral face (23) of the stack (3).

5. A fuel cell system (1) according to any of claims 1 to 4,
characterized in that the at least one cooling medium distribution space (15) has a plurality of cooling medium inlet openings (16) and/or the at least one cooling medium collection space (18) has a plurality of cooling medium outlet openings (19).

6. A fuel cell system (1) according to any of claims 1 to 5,
characterized in that a plurality of cooling medium distribution spaces (15) is provided which are arranged on the same lateral face (23) or on different lateral faces (23, 23′) of the stack (3) and/or a plurality of cooling medium collection spaces (18) is provided which are arranged on the same lateral face (23) or on different lateral faces (23, 23′) of the stack (3).

7. A fuel cell system (1) according to any of claims 1 to 6,
characterized in that the at least one cooling medium distribution space (15) has a cooling medium distributing structure (17) arranged therein.

8. A fuel cell system (1) according to any of claims 1 to 7,
characterized in that the individual fuel cells (2) are each provided with at least one fuel gas supply (30) and/or at least one fuel gas discharge (31) and/or at least one oxidant supply (32) and/or at least one oxidant discharge (33), which are arranged internally of the space permitting the flow of cooling medium (13) therethrough.

9. A fuel cell system (1) according to any of claims 1 to 8,
characterized in that current collectors (21) are arranged at the ends of the stack (3) such that an intermediate space (10) for receiving a cooling medium (13) is provided between a current collector (21) and the adjacent individual fuel cell (2).

10. A fuel cell system (1) according to any of claims 1 to 9,
characterized in that seals (26) are provided between cooling medium distribution space (15) and at least one lateral face (23, 24) of the stack (3) and between cooling medium collection space (18) and at least one lateral face (23, 24) of the stack (3).

11. A fuel cell system (1) according to any of claims 1 to 10,
characterized in that the stack (3) is confined by end plates (22) and that sealing means (27) are provided between the end plates and the walls of the cooling medium distribution space (15) and/or the end plates (22) and the walls of the cooling medium collection space (18).

12. A fuel cell system (1) according to any of claims 1 or 3 to 11,
characterized in that spacers (11) are arranged at least in part of the intermediate spaces (10).

13. A fuel cell system (1) according to claim 12,
characterized in that the spacers (11) constitute cooling medium flow paths (14).

14. A fuel cell system (1) according to claim 12 or 13,
characterized in that the spacers (11) are electrically conductive.

15. A fuel cell system (1) according to any of claims 12 to 14,
characterized in that all external surfaces of the individual fuel cells (2) and the spacers (11) are coated with electrically insulting material and/or protective material.

16. A fuel cell system (1) according to any of claims 2 or 5 to 9,
characterized in that the at least one cooling medium distribution space (15) and the at least one cooling medium collection space (18) are part of a cooling medium jacket completely surrounding the stack (3).

17. A fuel cell system (1) according to claim 16,
characterized in that the cooling medium jacket has cooling medium jacket lateral faces arranged on mutually opposite laterally faces (24, 24′) of the stack (3), with a free space for receiving cooling medium (13) being provided between at least one cooling medium jacket lateral face and the opposing lateral face (24, 24′) of the stack (3).

18. A method of cooling a fuel cell system (1) comprising a plurality of individual polymer electrolyte membrane fuel cells (2) arranged one on top of the other in the form of a stack (3),
characterized in that a space is provided allowing the flow of cooling medium therethrough, said space having
intermediate spaces (10) between adjacent individual fuel cells (2) or passages (12) in bipolar plates (7) of adjacent individual fuel cells and
at least one cooling medium distribution space (15) arranged on a lateral face (23) of the stack (3), and
at least one cooling medium collection space (18) arranged on a lateral face (23, 23′) of the stack (3), and
that a fluid cooling medium (13) is flown through said space allowing the flow of cooling medium therethrough.

19. A method according to claim 18,
characterized in that a plurality of cooling medium distribution spaces (15) and/or collection spaces (18) are provided for cooling various regions of the stack (3), the various cooling medium distribution spaces (15) being fed with cooling medium (13) of different volume flows and/or different temperature, if desired.

20. A method according to claim 18 or 19,
characterized in that the cooling medium flows through the intermediate spaces (10) or through the passages (12) in a hydraulic parallel connection.

21. A method according to any of claims 18 to 20,
characterized in that the cooling medium flows through various regions of an intermediate space (10) or through various passages (12) within a bipolar plate (7) at different speeds.

22. A method according to any of claims 18 to 21,
characterized in that an electrically non-conducting, weakly conducting or highly conducting, aqueous or non-aqueous fluid medium is used as cooling medium.

23. A method according to any of claims 18 to 22,
characterized in that heated cooling medium leaving the fuel cell system (1) is introduced directly into a heating circuit.

24. A method according to any of claims 18 to 23,
characterized in that the pressure loss between entry of the cooling medium (13) into the stack (3) and discharge of the cooling medium (13) from the stack is less than 50000 Pa, preferably less than 5000 Pa.

25. A method according to any of claims 18 to 24,
characterized in that the cooling medium (13) used is a non-aqueous, preferably electrically insulating cooling medium or a cooling medium containing anti-freeze agent.

26. A method according to any of claims 18 to 25,
characterized in that the supply means (30) and/or the discharge means (31) for fuel gas and/or the supply means (32) and/or the discharge means (33) for oxidant to the individual fuel cells (2) are arranged in the space permitting the flow of cooling medium (13) therethrough, and the cooling medium flows around these supply and/or discharge means.
